(19) United States
(12) Patent Application Publication
(10) Pub. No.: US 2011/0205589 A1
(43) Pub. Date: Aug. 25, 2011

(54) STORAGE DEVICE, SUBSTRATE, LIQUID CONTAINER, HOST DEVICE, AND SYSTEM

(75) Inventor: Jun Sato, Shiojiri-shi (JP)

(73) Assignee: SEIKO EPSON CORPORATION, Shinjuku-ku (JP)

(21) Appl. No.: 13/031,137

(22) Filed: Feb. 18, 2011

(30) Foreign Application Priority Data
Feb. 22, 2010 (JP) 2010-035769

(51) Int. Cl. G06F 3/12

(52) U.S. Cl. 358/1.15

(57) ABSTRACT

A storage device includes a storage section, a storage control section that controls access of the storage section, a control section that performs a process of communicating with a host device, and first to k-th (k is an integer of 2 or more) terminals. The control section outputs, to the host device, a response signal to give a notification that the corresponding storage device is connected, through an i-th (i is an integer where 1≦i≦k) terminal among the first to k-th terminals. The control section outputs the response signal to the host device in an m-th (m is an integer where 1≦m≦n) output time period, which corresponds to ID information of the corresponding storage device, among first to n-th (n is an integer of 2 or more) output time periods.

### BACKGROUND

1. Technical Field

The present invention relates to a storage device, a substrate, a liquid container, a host device, a system, and the like.

2. Related Art

In printers used in which ink cartridges are mounted, in order to prevent a printing process from being executed in a state where the ink cartridges are not mounted, it is necessary to detect whether or not the ink cartridges are mounted.

In regards to this issue, for example, JP-A-2002-14870 discloses a method of detecting whether or not the ink cartridges are mounted by detecting whether or not they are electrically conducted through detection terminals provided in a printer and ink cartridges. However, in this method, there is a problem in that, for example, the number of terminals increases.

Further, for example, JP-A-2009-274438 discloses a method of using a terminal for detecting a remaining ink level in detecting whether or not the ink cartridges are mounted. However, in this method, there is a problem in that, for example, when the method of detecting the remaining ink level is changed to another method, it is difficult to decrease the number of terminals.

### SUMMARY

An advantage of some aspects of the invention is to provide a storage device, a substrate, a liquid container, a host device, a system or the like capable of efficiently detecting connection while suppressing an increase in the number of terminals.

According to a first aspect of the invention, a storage device includes: a storage section; a storage control section that controls access of the storage section; a control section that performs a process of communicating with a host device; and first to k-th (k is an integer of 2 or more) terminals. The control section outputs, to the host device, a response signal to give a notification that the corresponding storage device is connected, through an i-th (i is an integer where 1≦i≦k) terminal among the first to k-th terminals. The control section outputs the response signal to the host device in an m-th (m is an integer where 1≦m≦n) output time period, which corresponds to ID information of the corresponding storage device, among first to n-th (n is an integer of 2 or more) output time periods.

In the first aspect of the invention, it is possible to output the response signal, which is to give a notification that the corresponding storage device is connected, to the host device through the i-th terminal among the first to k-th terminals. Hence, the terminal for detecting the connection is not necessary, and thus it is possible to reduce the number of terminals. Further, since it is possible to detect whether or not each storage device is connected in each output time period, it is possible to shorten detection time. Furthermore, since the response signal transmitted from each storage device is output in the m-th output time period corresponding to the ID information of each storage device, the host device is able to identify which storage devices are not connected. As a result, it is possible to efficiently detect the connection of the storage device.

Further, in the first aspect of the invention, it is preferable that the control section should include a mode determination portion that determines whether an operation mode is a normal communication mode or a connection detection mode, and a response portion that issues an instruction to output the response signal. In addition, it is also preferable that, when it is determined that the operation mode is the connection detection mode, the response portion should issue the instruction to output the response signal in the m-th output time period.

In such a manner, when it is determined that the operation mode is the connection detection mode, it is possible to issue the instruction to output the response signal. Hence, it is possible to perform a control process for the connection detection separately from the normal communication mode. By performing the control process separately from the normal communication mode, it is possible to restrict the access to the storage section within the ID information. Thus, it is possible to prevent the storage data from unintentionally being damaged.

Further, in the first aspect of the invention, it is preferable that the first to k-th terminals should include a reset terminal. In addition, it is also preferable that the mode determination portion should determine that the operation is the connection detection mode when a voltage level of the reset terminal is a voltage level representing a reset state in a predetermined time period after power activation.

In such a manner, in the predetermined time period after the power activation, it is possible to determine the operation mode depending on whether or not the voltage level of the reset terminal is the voltage level representing the reset state. With such a configuration, it is possible to not use a particular signal for setting the operation mode, and thus it is possible to reduce the number of terminals.

Further, in the first aspect of the invention, it is preferable that, in the m-th output time period, the response portion should change a voltage level of the i-th terminal from a high-impedance state to a second voltage level, and then changes the voltage level thereof from the second voltage level to a first voltage level. In addition, it is preferable that, in a time period other than the m-th output time period, the response portion should set the voltage level of the i-th terminal to the high-impedance state.

In such a manner, it is possible for the influence of the storage device to have no impact on the response signal, which is output from another storage device, in the time period other than the m-th output time period by outputting the response signal in the m-th output time period corresponding to the personal-ID information.

Further, in the first aspect of the invention, it is preferable that the response portion should include a counter that performs a process of counting an internal clock, and a consistent determination section that determines consistency between a count value of the counter and a latency value corresponding to the ID information which is read out from the storage section. In addition, it is preferable that, when the count value is consistent with the latency value, the response portion should issue the instruction to output the response signal.

In such a manner, it is possible to output the response signal at the timing after the latency period corresponding to the ID information has passed. Hence, in the output time period corresponding to the ID information, it is possible to reliably output the response signal.

Further, in the first aspect of the invention, it is preferable that the counter should start a process of counting the internal clock at a timing when power-on reset is released after power activation.

In such a manner, the process of counting the internal clock is started at the timing when the power-on reset is released. Hence, it is possible to output the response signal at the timing after the latency period corresponding to the ID information has passed from the time of releasing the power-on reset. As a result, in the output time period corresponding to the ID information, it is possible to reliably output the response signal.

Further, in the first aspect of the invention, it is preferable that the response portion should issue the instruction to output the response signal through a plurality of terminals among the first to k-th terminals.

In such a manner, it is possible to perform the detection as to whether or not each terminal is electrically connected on the plurality of terminals.

According to a second aspect of the invention, a substrate includes the above-mentioned storage device.

According to a third aspect of the invention, a liquid container includes the above-mentioned storage device.

According to the third aspect of the invention, it is possible to efficiently detect whether or not the storage device included in the liquid container is appropriately connected. Consequently, it is possible to efficiently detect whether or not the liquid container is appropriately mounted.

According to a fourth aspect of the invention, a system includes the above-mentioned storage device and a host device.

According to the fourth aspect of the invention, the host device is able to efficiently detect whether or not the storage device is appropriately connected. As a result, it is possible to improve reliability of the system.

According to the fifth aspect of the invention, a host device includes: a communication processing section that performs a process of communicating with first to n-th (n is an integer of 2 or more) storage devices through first to k-th (k is an integer of 2 or more) host side terminals; and a monitoring section. The monitoring section monitors whether or not response signals are output from the first to n-th storage devices in each time period of first to n-th output time periods.

According to the fifth aspect of the invention, by monitoring presence or absence of the response signal in each output time period of the first to n-th output time periods, it is possible to detect whether the storage device is connected. Hence, for example, it is possible to shorten the detection time. As a result, for example, it is possible to efficiently detect the connection of the storage device.

### BRIEF DESCRIPTION OF THE DRAWINGS

The invention will be described with reference to the accompanying drawings, wherein like numbers reference like elements.

FIG. 1 is a basic configuration example of a system.

FIG. 2 is a basic configuration example of a storage device.

FIGS. 3A and 3B are examples of timing charts of the storage device.

FIG. 4 is an example of a flowchart illustrating operations of a mode determination portion.

FIG. 5 is a basic configuration example of a response portion.

FIG. 6 is an example of a flowchart illustrating operations of the response portion.

FIG. 7 is an example of latency values and lengths of respective time periods of response signals.

FIG. 8 is an example of a correspondence relationship between ID information and output time periods.

FIG. 9 is a specific configuration example of the liquid container.

FIGS. 10A and 10B are specific configuration examples of a circuit board.

FIG. 11 is a basic configuration example of a host device.

### DESCRIPTION OF EXEMPLARY EMBODIMENTS

Hereinafter, preferred embodiments of the invention will be described in detail. The embodiments described below do not limit the invention, and not all the configurations described in the embodiments are necessarily required as means for resolution of the invention.

### 1. Basic Configuration Example of System

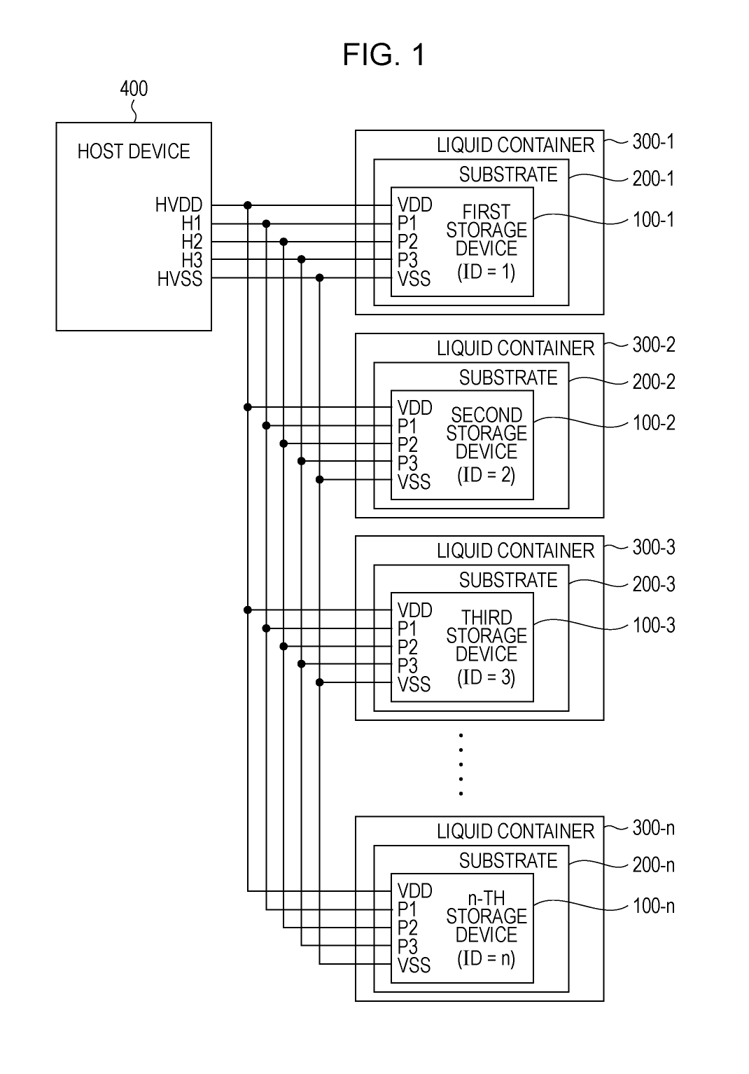

FIG. 1 shows a basic configuration example of the system according to the embodiment. In the basic configuration example of the system according to the embodiment, the system includes first storage device 100-1 to n-th (n is an integer of 2 or more) storage device 100-n, n substrates 200-1 to 200-n having the storage devices mounted thereon, n liquid containers 300-1 to 300-n having the substrates mounted thereon, and a host device 400. In addition, the system according to the embodiment is not limited to the configuration of FIG. 1, and may be modified into various forms. For example, a part of a component may be omitted, or another component may be added.

Each of the first to n-th storage devices 100-1 to 100-n includes first to k-th terminal P1 to Pk (k is an integer of 2 or more), a first power supply terminal VSS, and a second power supply terminal VDD, respectively. It should be noted that FIG. 1 shows the case of k=3 as an example but the value of k is arbitrary. Further, as described later, each of the n storage devices 100-1 to 100-n includes a storage section (for example, a non-volatile memory, or the like). The respective storage sections store ID (Identification) information (for example, ID=1, ID=2, ID=3, and the like) for identifying n liquid containers (such as ink cartridges) 300-1 to 300-n. Different IDs are assigned thereto in accordance with the types such as colors of the liquids contained in the liquid containers.

Each storage device has a normal communication mode (a normal operation mode) and a connection detection mode as operation modes. The normal communication mode is a mode for transmitting the data of the storage section to the host device or updating data of the storage section into data received from the host device. The connection detection mode is defined as an operation mode of the storage device used when detecting whether or not each storage device is connected to the host device.

In the connection detection mode, each storage device outputs the response signal, which is to give a notification that the corresponding storage device is connected, to the host device 400 through an i-th terminal Pi (i is an integer where 1≦i≦k) among first to k-th terminals P1 to Pk. The response signal is output in an m-th (m is an integer where 1≦m≦n) output time period corresponding to the ID information of each storage device.

For example, as shown in FIG. 1, the ID information of the first storage device 100-1 may be set so that ID=1, and the ID information of the second storage device 100-2 may be set so that ID=2. In this case, the first storage device 100-1 outputs the response signal in the first output time period, and the second storage device 100-2 outputs the response signal in the second output time period.

The host device 400 includes first to k-th (k is an integer of 2 or more) host side terminals H1 to Hk. The host device 400 is, for example, a printer main body, and as described later, and is able to determine whether or not the respective storage devices are connected, that is, whether or not the liquid containers 300-1 to 300-n are mounted, on the basis of the response signals transmitted from the storage device 100-1 to 100-n.

As described above, in the system according to the embodiment, each storage device 100 is able to output the response signal, which is to give the notification that the corresponding storage device is connected, to the host device 400 through the i-th terminal Pi among the first to k-th terminals P1 to Pk. In such a manner, the terminal for detecting presence or absence of the liquid container 300 becomes unnecessary, and thus it is possible to reduce the number of terminals. Further, since it is possible to detect whether or not each storage device is connected in each output time period, it is possible to shorten the detection time. Furthermore, the response signal from each storage device is output in the m-th output time period corresponding to the ID information of each storage device. Hence, the host device 400 is able to identify which storage devices (liquid containers) of the n storage devices (liquid containers) are not mounted.

Further, in the system according to the embodiment, each storage device 100 is able to output the response signal to the host device 400 through the plural terminals among the first to k-th terminals P1 to Pk. With such a configuration, it is possible to perform the detection as to whether or not each terminal is electrically connected to the plurality of terminals.

### 2. Storage Device

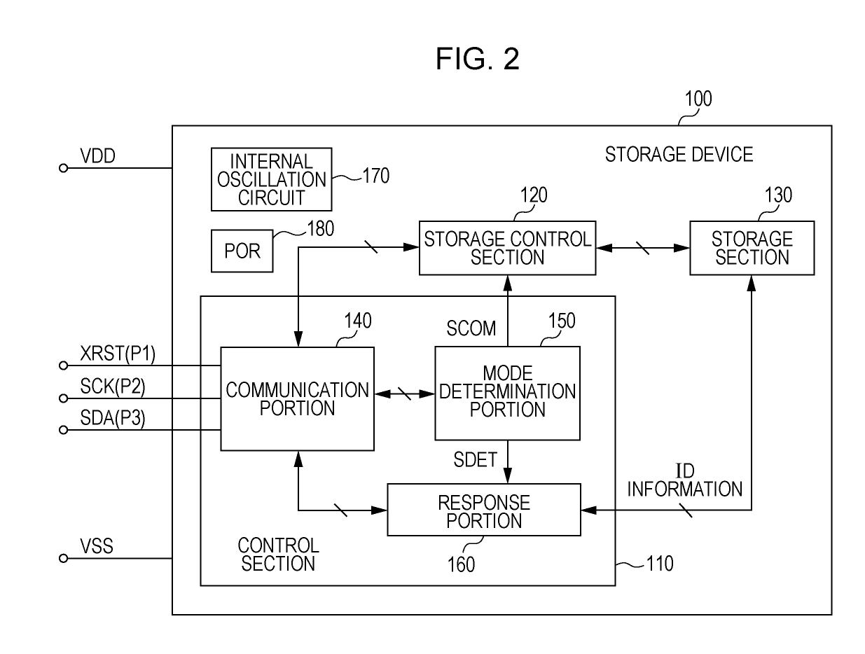

FIG. 2 shows a basic configuration example of the storage device 100 according to the embodiment. The storage device 100 according to the embodiment includes a control section 110, a storage control section 120, a storage section 130, a reset terminal XRST (a first terminal P1 in a wider sense), a clock terminal SCK (a second terminal P2 in a wider sense), and a data terminal SDA (a third terminal P3 in a wider sense). In addition, the storage device 100 according to the embodiment is not limited to the configuration of FIG. 2, and may be modified into various forms. For example, a part of a component may be omitted, or other components may be added.

The storage section 130 stores the ID information input at the time of manufacture, the manufacture information, and the information input from the host device 400. For example, in the case of the ink cartridge, the storage section 130 stores the manufacture date information as manufacture information, ink color information, and the like, and stores the information on the remaining ink level as information input from the host device 400. The storage section 130 is formed of a non-volatile memory such as an FERAM (a ferroelectric memory) or a flash memory.

In addition, in the configuration, it is not always necessary to store the ID information for indentifying the storage device 100 in the storage section 130 such as a non-volatile memory. For example, it is possible to store the ID information by using a fuse element, or it is possible to output the ID information by using a logic circuit.

The storage control section 120 controls access of the storage section 130 in the normal communication mode (the normal operation mode).

The control section 110 includes a communication portion 140, a mode determination portion 150, and a response portion 160. The communication portion 140 communicates with the host device 400. The mode determination portion 150 determines whether the operation mode is the normal communication mode (the normal operation mode) or the connection detection mode.

The normal communication mode (the normal operation mode) is an operation mode for performing data communication for interchanging data on the remaining ink level and the like between the host device 400 and the storage device 100.

The connection detection mode is an operation mode for detecting whether or not the storage device 100 is connected.

The mode determination portion 150 determines that the operation is the connection detection mode when the voltage level of the reset terminal XRST is a voltage level representing a reset state in a predetermined time period after power activation. When it is determined that the operation mode is the normal communication mode, a control signal SCOM for the storage control section 120 is set to the active level. When it is determined that the operation mode is the connection detection mode, a control signal SDET for the response portion 160 is set to the active level.

When it is determined that the operation mode is the connection detection mode, the response portion 160 issues an instruction to output, to the communication section 140, the response signal to give the notification that the storage device is connected. Specifically, when the control signal SDET supplied from the mode determination portion 150 is at the active level, the response portion 160 reads out the ID information stored in the storage section 130, and issues the instruction to output the response signal to the communication section 140 in the m-th output time period corresponding to the ID information. The response signal is output to the host device 400 through the several terminals of the reset terminal XRST, the clock terminal SCK, and the data terminal SDA.

An internal oscillation circuit 170 generates the internal clock of the storage device 100, and supplies the clock to the control section 110, the storage control section 120, and the storage section 130.

A power-on reset (POR) circuit 180 performs a power-on reset process on the basis of the second power source voltage VDD. That is, the storage device 100 is in the reset state until the power is applied, and when the power is applied, the reset of the storage device 100 is released. Specifically, the power-on reset circuit 180 sets the power-on reset signal POROUT to the H level (the high potential level, that is, a second voltage level in a wider sense), when power is applied to the host device 400 and the difference between second power source voltage VDD and the first power source voltage VSS is equal to or more than a threshold voltage (a predetermined voltage).

As described above, in the storage device according to the embodiment, it is possible to output the response signal, which is to give the notification that the corresponding storage device is connected, to the host device through the above several terminals (or plural terminals) such as the reset terminal XRST, the clock terminal SCK, and the data terminal SDA. With such a configuration, the terminal for detecting presence or absence of each storage device (each liquid container) becomes unnecessary, and thus it is possible to reduce the number of terminals. Furthermore, in the case of the connection detection mode, it suffices to read out only the ID information from the storage section. Hence, by forbidding (masking) access to another data, it is possible to prevent storage content from being unintentionally damaged.

Further, since it is possible to detect presence or absence of each storage device in each time period, it is possible to shorten the detection time. Furthermore, the response signal supplied from each storage device is output in the m-th output time period corresponding to the ID information of each storage device. Hence, the host device is able to identify which storage device (liquid container) is not mounted.

On the other hand, in the method of detecting presence or absence of the liquid container by using the normal communication mode (the normal operation mode), it is necessary to wait until time-out error occurs in communication. For this reason, it takes time before the detection, and thus there is a concern about occurrence of errors during the communication. As a result, even though the liquid container may be mounted, there is a possibility that it is determined that the liquid container is not mounted.

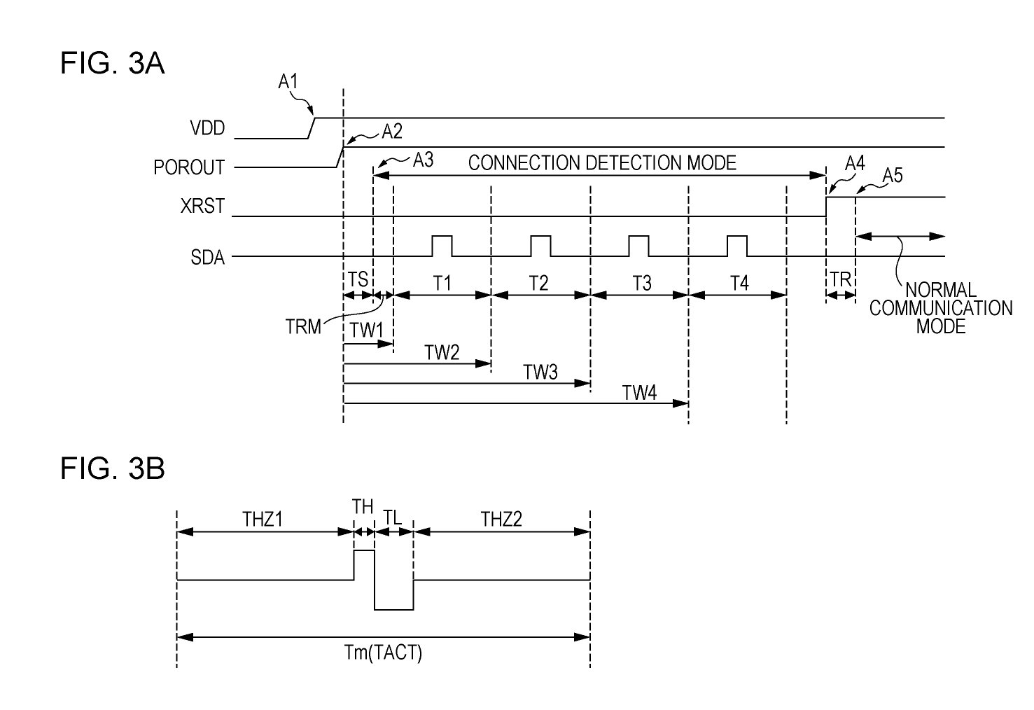

FIGS. 3A and 3B show examples of timing charts of the storage device 100. FIG. 3A is a timing chart of a second power source voltage VDD, a reset signal (a signal which is input to the reset terminal XRST in a wider sense), a clock signal (a signal which is input to the clock terminal SCK in a wider sense), and a data signal (a signal which is input/output from/to the data terminal SDA in a wider sense). FIG. 3A shows an exemplary case where the response signal is output through the data terminal SDA, but as described above, the response signal may be output through a different terminal (for example, a clock terminal SCK or a reset terminal XRST). Further, the response signal may be output through the plural terminals mentioned above.

Referring to FIG. 3A, the operation of the storage device 100 will be described. First, the second power source voltage VDD rises up (A1 in FIG. 3A), and the VDD reaches the predetermined voltage. Then, the power-on reset (POR) circuit 180 sets the power-on reset signal POROUT to the H level (the high potential level, that is, the second voltage level in a wider sense), thereby releasing the power-on reset (A2 in FIG. 3A).

In the predetermined time period (the start-up period) TS which is started at the timing when the power-on reset is released, the voltage level of the reset terminal XRST may be held at the voltage level representing the reset state (the L level). In this case, the mode determination portion 150 determines that the operation mode is the connection detection mode (A3 in FIG. 3A).

when the mode determination portion 150 determines that the operation mode is the connection detection mode, in an ID-information readout period TRM, the response portion 160 reads out the ID information from the storage section 130.

Next, the response portion 160 outputs the response signal in the m-th output time period Tm corresponding to the read ID information. Specifically, for example, as shown in FIG. 3A, the storage device 100-1 with ID=1 outputs the response signal in the first output time period T1. The storage device 100-2 with ID=2 outputs the response signal in the second output time period T2. Likewise, the storage devices with ID=3 and 4 respectively output the response signal in the third and fourth output time periods T3 and T4.

More specifically, as shown in FIG. 3A, after the elapse of the latency period TW (TW1˜TW4) which is started at the timing when the power-on reset is released (A2 in FIG. 3A), each storage device sequentially outputs the response signal. That is, the storage device 100-1 with ID=1 outputs the response signal after the elapse of the latency period TW1, and the storage device 100-2 with ID=2 outputs the response signal after the elapse of the latency period TW2. Likewise, the storage devices with ID=3 and 4 respectively output the response signal after the elapse of the latency periods TW3 and TW4.

In the m-th output time period Tm, the response portion 160 changes the voltage level of the i-th terminal Pi, which is a terminal for outputting the response signal, from the high-impedance state (Hi-Z) to the second voltage level (the H level), and then changes the voltage level thereof to the first voltage level (the L level). On the other hand, in the time period other than the m-th output time period Tm, the voltage level of the i-th terminal Pi is set to the high-impedance state. With such a configuration, it is possible to output each response signal with a time delay (in a time-division manner). Hence, it is possible to identify which storage device outputs the response signal, and it is possible to prevent the respective response signals from interfering with each other.

After the connection detection is completed, the voltage level of the reset terminal XRST may be changed to the voltage level (the H level) representing the reset release state (A4 in FIG. 3A), and the voltage level may be held in the predetermined time period TR. In this case, the mode determination portion 150 determines that the operation mode is the normal communication mode (A5 in FIG. 3A).

FIG. 3B is a specific timing chart of the response signal in the output time period Tm. In the m-th output time period Tm, the response signal holds the high-impedance state (Hi-Z) in the first high-impedance holding period THZ1. Next, the response signal changes to the second voltage level (the H level), and holds the H level in the H-level holding period TH. Then, the response signal changes to the first voltage level (the L level), and holds the L level in the L-level holding period TL. Then, the response signal returns to the high-impedance state (Hi-Z) again, and holds the high-impedance state (Hi-Z) in the second high-impedance holding period THZ2.

As described above, by holding the high-impedance state (Hi-Z) in the first-half and latter-half time periods of the output time period Tm (the active time period TACT) of the response signal, the response signal may be output in the two output time periods (for example, the second and third output time periods) adjacent to each other. In this case, it is possible to prevent the two response signals from interfering with each other.

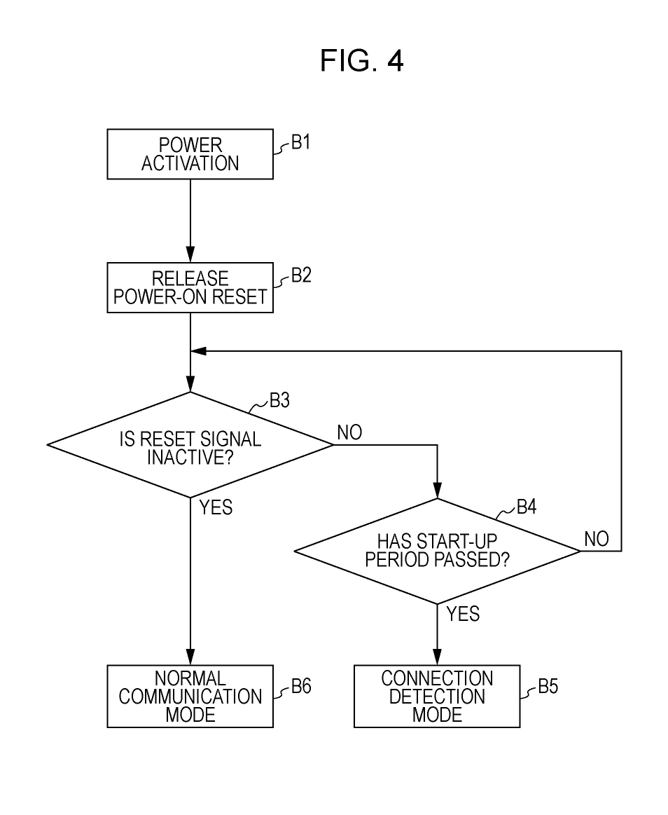

FIG. 4 is an example of a flowchart illustrating operations of the mode determination portion 150. Hereinafter, referring to the steps B1 to B6 in the flowchart of FIG. 4, the operations of the mode determination portion 150 will be described.

First, the second power VDD is applied to the storage device 100 (step B1). Next, when the voltage of the second power source VDD reaches a predetermined voltage, the power-on reset (POR) circuit 180 sets the power-on reset signal POROUT to the H level, thereby releasing the power-on reset (step B2). In such a manner, each circuit included in the storage circuit 100 starts the operation thereof.

Then, it is determined that the reset signal (the voltage level of the reset terminal XRST) is at the inactive level (the H level) (step B3). When the reset signal is not at the inactive level, that is, when the reset signal is at the active level (the L level), it is determined whether or not the predetermined start-up period TS has passed (step B4).

When the predetermined start-up period TS has passed, the mode determination portion 150 determines that the operation mode is the connection detection mode (step B5). In contrast, when the predetermined start-up period TS has not passed, the flow returns to the determination in step B3.

Further, on the basis of the determination in step B3, when the reset signal is at the inactive level, the mode determination portion 150 determines that the operation mode is the normal communication mode (step B6).

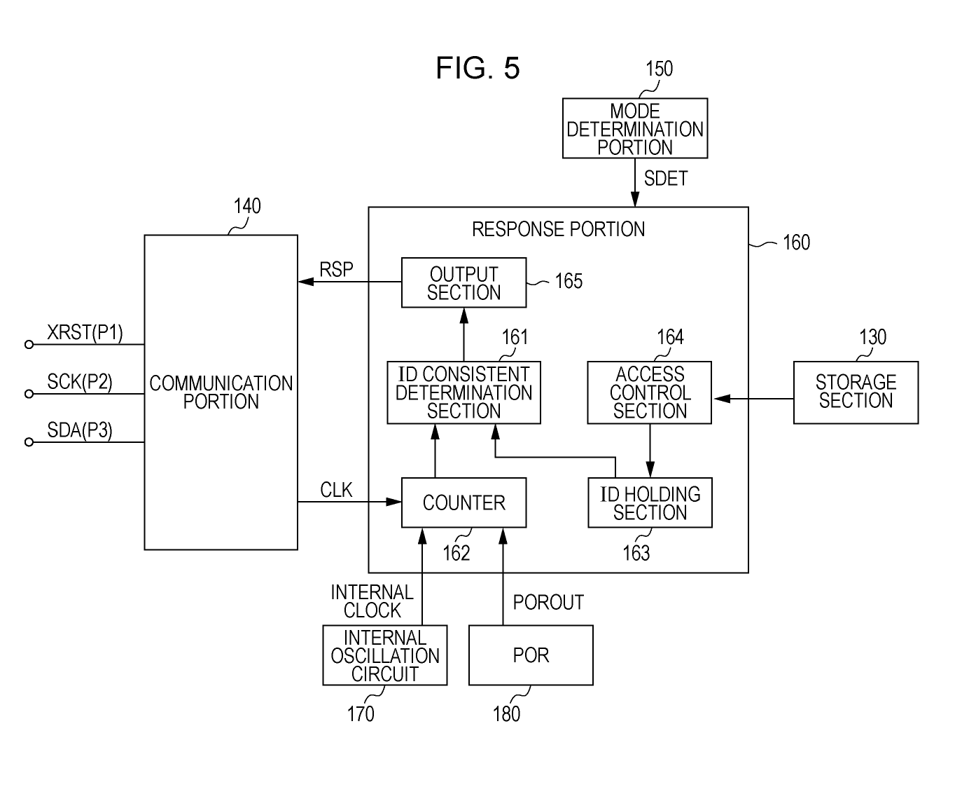

FIG. 5 shows a basic configuration example of the response portion 160. The response portion 160 includes an ID consistent determination section 161, a counter 162, an ID holding section 163, an access control section 164, and an output section 165.

The ID consistent determination section 161 (the consistent determination section in a wider sense) determines that the count value of the counter 162 is consistent with the latency value TW corresponding to the ID information which is read out from the storage section 130. The counter 162 performs a process of counting the internal clock. The ID holding section 163 holds the value of the ID information which is read out from the storage section 130, and outputs the value to the ID consistent determination section 161. The access control section 164 accesses the storage section 130 and reads out the value of the stored ID information. The output section 165 issues the output instruction RSP to output the response signal to the communication section 140 on the basis of the determination result of the ID consistent determination section 161.

When the count value is consistent with the latency value TW, the response portion 160 outputs the instruction to output the response signal. Specifically, for example, as shown in the above-mentioned timing chart of FIG. 3A, at the timing when the power-on reset is released (A2 in FIG. 3A), the counter 162 starts the process of counting the internal clock. When the predetermined start-up period TS has passed, the mode determination portion 150 determines that the operation mode is the connection detection mode (A3 in FIG. 3A), the control signal SDET is set to the active level. Then, the access control section 164 reads out the ID information from the storage section 130 in the ID-information readout period TRM, and the ID holding section 163 holds the value of the ID information.

Then, the ID consistent determination section 161 determines whether or not the count value of the counter 162 is consistent with the latency value TW corresponding to the ID information. When there is consistency between the values, the output instruction RSP to output the response signal is output from the output section 165 to the communication section 140. For example, as shown in FIG. 3A, the storage device with ID=1 outputs the response signal after the elapse of the latency period TW1, and the storage device with ID=2 outputs the response signal after the elapse of the latency period TW2. In such a manner, in the output time period corresponding to the ID information of each storage device, the response signal is output.

The communication section 140 outputs the response signal to the host device 400 through the i-th terminal Pi among the first to k-th terminals P1 to Pk, on the basis of the output instruction RSP transmitted from the response portion 160. For example, in FIG. 5, the response signal is output through a reset terminal XRST (a first terminal P1 in a wider sense), a clock terminal SCK (a second terminal P2 in a wider sense), and a data terminal SDA (a third terminal P3 in a wider sense). Moreover, the response signal may be output through the plural terminals among the above-mentioned terminals.

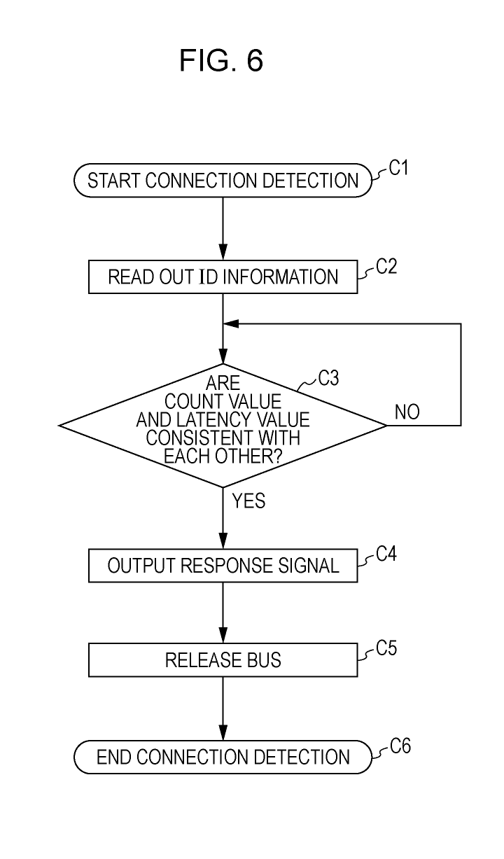

FIG. 6 is an example of a flowchart illustrating the operations of the response portion 160. Hereinafter, referring to steps C1 to C6 in FIG. 6, the operations of the response portion 160 will be described.

First, on the basis of the determination of the mode determination portion 150, the connection detection mode starts (step C1). Then, in the ID-information readout period TRM, the ID information is read out from the storage section 130, and is held in the ID holding section 163 (step C2).

Next, it is determined whether or not the count value of the counter 162 is consistent with the latency value TW corresponding to the ID information (step C3). When both of them are consistent with each other, the response portion 160 issues the output instruction RSP to output the response signal to the communication section 140, and on the basis of the output instruction RSP, the communication section 140 outputs the response signal (step C4). Then, the bus, which is connected to the terminal through which the response signal is output, is released (step C5), and the connection detection is terminated (step C6).

In contrast, in the determination in step C3, when the count value is not consistent with the latency value TW corresponding to the ID information, the determination in step C3 is repeated until the both of them are consistent with each other.

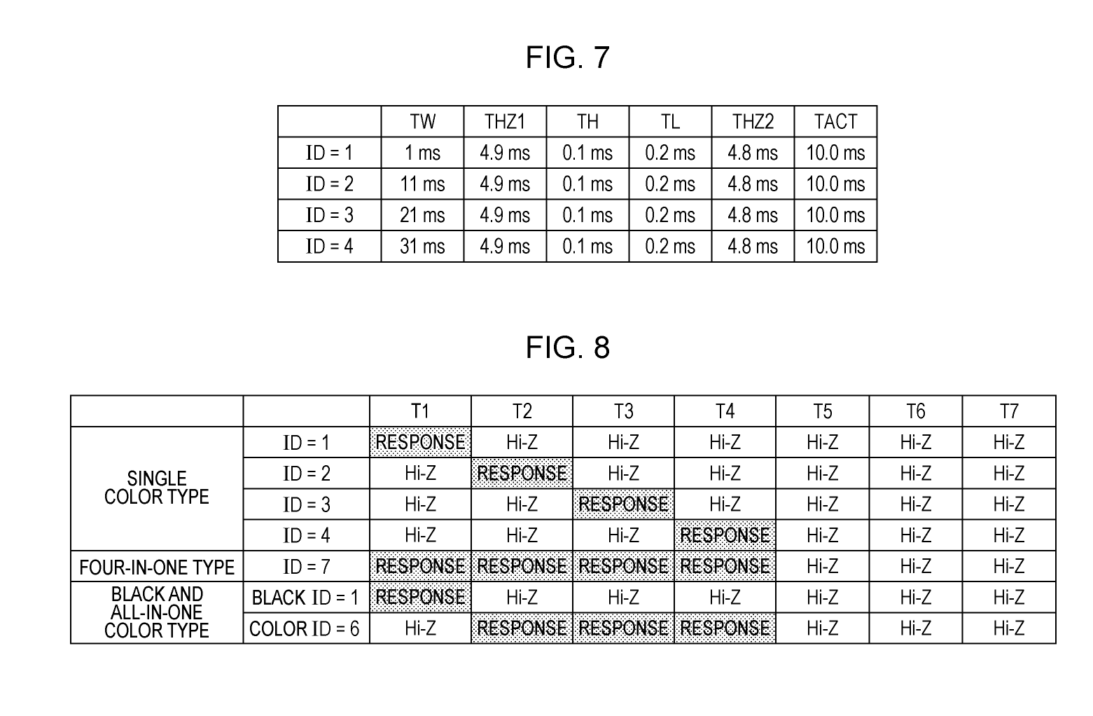

FIG. 7 is an example of the latency values TW corresponding to the ID information and the lengths of the respective time periods (THZ1, TH, TL, THZ2, and TACT) of the response signals. As shown in FIG. 3A, each latency value TW (TW1 to TW4) is a value of time from when the power-on reset is released until the output time period Tm of the response signal is started. Further, as shown in FIG. 3B, the first high-impedance holding period THZ1 is a time period, during which the high-impedance state (Hi-Z) is held, in the first-half time period of the output time period (the active time period TACT), and the H-level holding period TH and the L-level holding period TL are time periods during which the H level and L level are held respectively. The second high-impedance holding period THZ2 is a time period, during which the high-impedance state (Hi-Z) is held, in the latter-half time period of the output time period (the active time period TACT).

For example, when the ID information is set so that ID=1, the corresponding latency value TW1 is 1 ms, and when ID=2, the corresponding latency value TW2 is 11 ms. Likewise, the latency values TW3 and TW4 corresponding to ID=3 and 4 are 21 ms and 31 ms respectively. Further, the length of the active time period TACT of each response signal is 10 ms, the length of THZ1 is 4.9 ms, the length of TH is 0.1 ms, the length of TL is 0.2 ms, and the length of THZ2 is 4.8 ms.

In such a manner, it is possible to provide each output time period (active time period) TACT at the time interval of 10 ms. Further, the lengths of the high-impedance holding periods THZ1 and THZ2 are respectively set to be sufficiently longer than the lengths of the H-level and L-level holding periods TH and TL. Thereby, when the response signals are output in the two output time periods adjacent to each other, it is possible to prevent the two response signals from interfering with each other. For example, the internal oscillation circuit 170 for generating the internal clock may be configured to include a ring oscillator and the like. In this case, the variation in the oscillation frequency (the internal clock frequency) among the storage devices is likely to be caused by variation in transistor characteristics and the like. Further, at the timing when the power-on reset is released, the variation among the among the storage devices is also likely to be caused by variation in transistor characteristics and the like. Even in this case, by setting the high-impedance holding period so as to make it sufficiently long as described above, it is possible to prevent two adjacent response signals from interfering with each other.

In addition, the ID information is not limited to ID=1 to 4, and the value equal to or larger than the ID=5 or 6 may be used. In this case, for example, the latency values TW5, TW6, . . . may be set to 41 ms, 51 ms, . . . .

According to the storage device 100 and the liquid container 300 of the embodiments, it is possible to associate the ID information with the ink colors of the liquid containers (the ink cartridges and the like). For example, it is possible to associate four colors (black, cyan, magenta, and yellow) of the ink cartridges with ID=1 to 4, respectively.

FIG. 8 shows another example of the correspondence relationship between the ID information and the output time periods. FIG. 8 shows not only single-color-type liquid containers, in which each single liquid container (ink cartridge) contains each single color liquid (ink or the like), but also an all-in-one liquid container in which a single liquid container contains liquids with plural colors.

For example, when the single color type is used, as described above, ID=1 to 4 are associated with the liquid containers for the respective colors (black, cyan, magenta, and yellow), and the response signals RSP are output in the output time periods T1 to T4. Further, when the four-in-one type is used, the ID information is set so that ID=7, it is possible to output the response signals in the output time periods T1 to T4. Further, when the single black color type and the all-in-one color type are used in combination, by setting the ID information of the single black color type to ID=1, it is possible to output the response signal in the output time period T1, and by setting the ID information of the all-in-one color type to ID=6, it is possible to output the response signals in the output time periods T2 to T4.

As described above, in the storage device 100 according to the embodiment, the response portion 160 is able to issue the instruction to output the response signals in the plural output time periods among the first to n-th output time periods T1 to Tn. Further, in the liquid container 300 according to the embodiment, when the liquid container 300 contains liquids with plural colors, it is possible to output the response signals in the plural output time periods, corresponding to the plural colors, among the first to n-th output time periods T1 to Tn. With such a configuration, it is possible to associate the first to n-th output time periods with n-color inks, respectively. Hence, no matter whether the ink cartridge is the single color type or the all-in-one type, it is possible to make the ink cartridge compatible without changing the firmware of the host device.

### 3. Substrate and Liquid Container

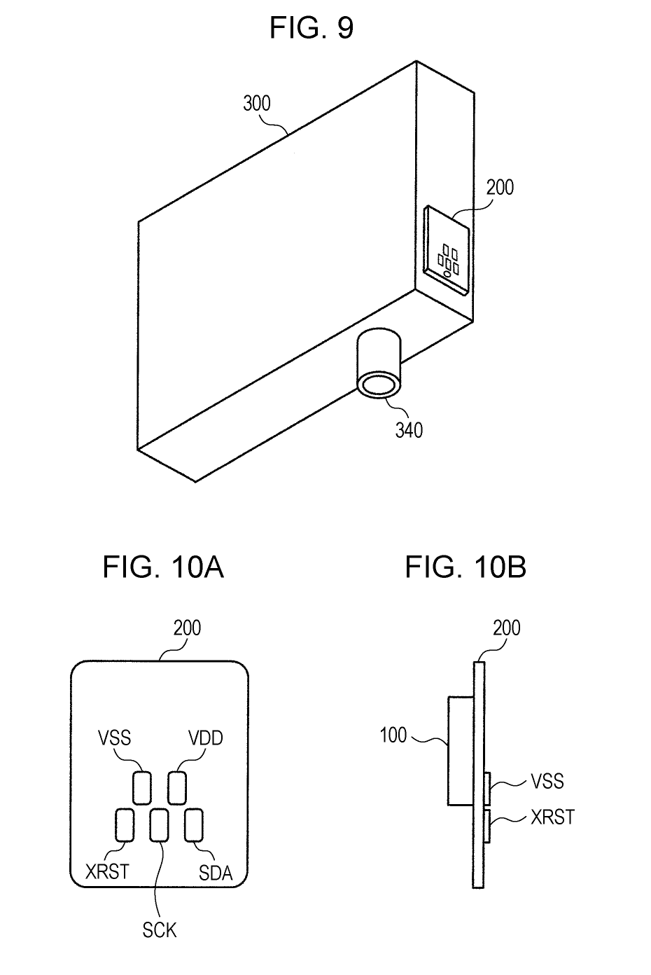

Next, a specific configuration example of the liquid container 300 equipped with the above-mentioned storage device 100 according to the embodiment will be described with reference to FIG. 9. Hereinafter, description will be given of an exemplary case where the host device 400 is an ink jet printer, the liquid container 300 is an ink cartridge, and a substrate 200 is a circuit board formed on the ink cartridge. Here, in the embodiment, the host device, the liquid container, and the substrate may be a different apparatus, a different container, or a different substrate. For example, the host device may be a reader/writer of the memory card, and the substrate may be a circuit board formed on the memory card.

In the ink cartridge 300 (the liquid container in a wider sense) shown in FIG. 9, an ink chamber, which is not shown in the drawing, for containing ink is formed. Further, in the ink cartridge 300, an ink supply port 340, which communicates with the ink chamber, is provided. The ink supply port 340 is for supplying the ink to the print head unit when the ink cartridge 300 is mounted in the printer.

The ink cartridge 300 includes the circuit board 200 (the substrate in a wider sense). The circuit board 200 is provided with the storage device 100 according to the embodiment, and stores the data or transmits and receives the data to and from the host device 400. The circuit board 200 is implemented by, for example, the print substrate, and is formed on the surface of the ink cartridge 300. The circuit board 200 is provided with a terminal such as the second power supply terminal VDD. In addition, when the ink cartridge 300 is mounted on the printer, by making the terminal come into contact with (electrically connect with) the terminal of the printer side, the power is applied or the data is interchanged.

FIGS. 10A and 10B show a specific configuration example of the circuit board 200 equipped with the storage device 100 according to the embodiment. As shown in FIG. 10A, a terminal group having plural terminals is provided on the surface (the surface which is connected to the printer) of the circuit board 200. The terminal group includes the first power supply terminal VSS, the second power supply terminal VDD, the reset terminal XRST, the clock terminal SCK, and the data terminal SDA. Each terminal is realized by the metal terminal formed in, for example, a rectangular shape (a substantially rectangular shape). In addition, each terminal is connected to the storage device 100 through a through hole or a wire pattern layer, not shown in the drawing, provided in the circuit board 200.

As shown in FIG. 10B, the storage device 100 according to the embodiment is provided on the rear surface (the surface opposite to the surface which is connected to the printer) of the circuit board 200. The storage device 100 can be realized by, for example, a semiconductor storage device having a ferroelectric memory. The storage device 100 stores various data relating to the ink or the ink cartridge 300. For example, the data on an amount of ink consumed and the ID information for identifying the ink cartridge 300 is stored. The data on the amount of ink consumed is data which represents, regarding the ink contained in the ink cartridge 300, the total sum of the amounts of the ink consumed in accordance with the execution of printing and the like. The data on the amount of ink consumed may be information representing the amount of ink within the ink cartridge 300 and may be information representing the rate of the amount of ink consumed.

### 4. Host Device

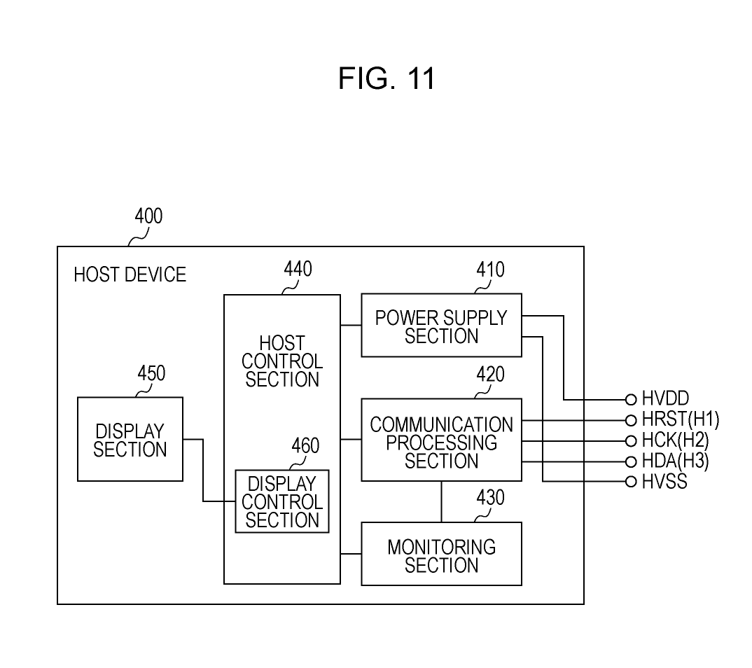

FIG. 11 shows a basic configuration example of the host device 400 according to the embodiment. The host device 400 is, for example, a printer main body, and includes a power supply section 410, a communication processing section 420, a monitoring section 430, a host control section 440, a display section 450, and a display control section 460. Furthermore, the host device 400 includes first to k-th (k is an integer of 2 or more) host side terminals H1 to Hk. Specifically, for example as shown in FIG. 11, the host device 400 includes a host side reset terminal HRST (a first host side terminal H1 in a wider sense), a host side clock terminal HCK (a second host side terminal H2 in a wider sense), a host side data terminal HDA (a third host side terminal H3 in a wider sense), a first host side power source terminal HVSS, and a second host side power source terminal HVDD.

The power supply section 410 supplies power to the first to n-th storage devices 100-1 to 100-n. The communication processing section 420 performs a process of communicating with the first to n-th storage devices 100-1 to 100-n through the first to k-th host side terminals such as the host side reset terminal HRST, the host side clock terminal HCK, and the host side data terminal HDA.

The monitoring section 430 monitors whether or not each response signal transmitted from the first to n-th storage devices 100-1 to 100-n is output in each period of the first to n-th output time periods T1 to Tn.

The host control section 440 performs respective processes of controlling the power supply section 410, the communication processing section 420, the monitoring section 430 and the display section 450.

The display section 450 is, for example, an LCD (a liquid crystal display) or the like, and displays an operation screen of the host device 400 (the printer), an operation state, an error message, or the like. In the connection detection mode, the display section 450 displays the connection detection result on the basis of the monitoring result of the monitoring section 430.

The display control section 460 controls the display of the connection detection result on the display section 450. The display control section 460 can be realized by the heretofore known display controller or the like.

As described above, in the storage device, host device, and the like according to the embodiment, it is possible to output the response signal, which is for giving the notification that the corresponding storage device is connected, to the host device through the above several terminals (or plural terminals) such as the reset terminal XRST, the clock terminal SCK, and the data terminal SDA. With such a configuration, the terminal for detecting presence or absence of each storage device (each liquid container) becomes unnecessary, and thus it is possible to reduce the number of terminals. Further, by outputting the response signals through the plural terminals, it is possible to perform the detection as to whether or not each terminal is electrically connected.

Further, since it is possible to detect presence or absence of each storage device in each time period, it is possible to shorten the detection time. Furthermore, the response signal supplied from each storage device is output in the m-th output time period corresponding to the ID information of each storage device. Hence, the host device is able to identify which storage device (liquid container) is not mounted.

Further, in the case of the connection detection mode, it suffices to read out only the ID information from the storage section. Hence, by forbidding (masking) access to other data, it is possible to prevent storage content from being unintentionally damaged.

Although the invention has been described in detail with respect to the examples thereof, it should be understood by those skilled in the art that the invention may be modified into various forms without departing from the technical scope of the invention. Accordingly, it should be understood that the scope of the invention includes the modified examples. For example, in the description or the drawings, the terms (such as the L level and the H level), which are described at least once together with the broadly-defined or synonymous different terms (such as the first voltage level and the second voltage level), may be replaced with the different corresponding terms even when existing at any place in the description or the drawings. Further, the configurations and the operations of the storage device, the substrate, the liquid container, the host device, and the system is not limited to the embodiments mentioned above, and may be modified into various forms.

The entire disclosure of Japanese Patent Application No. 2010-035769, filed Feb. 22, 2010 is expressly incorporated by reference herein.

What is claimed is:

1. A storage device comprising:
a storage section;
a storage control section that controls access of the storage section;
a control section that performs a process of communicating with a host device; and
first to k-th (k is an integer of 2 or more) terminals,
wherein the control section outputs, to the host device, a response signal to give a notification that the corresponding storage device is connected, through an i-th (i is an integer where 1≦i≦k) terminal among the first to k-th terminals, and
wherein the control section outputs the response signal to the host device in an m-th (m is an integer where 1≦m≦n) output time period, which corresponds to ID information of the corresponding storage device, among first to n-th (n is an integer of 2 or more) output time periods.

2. The storage device according to claim 1,
wherein the control section includes
a mode determination portion that determines whether an operation mode is a normal communication mode or a connection detection mode, and
a response portion that issues an instruction to output the response signal, and
wherein when it is determined that the operation mode is the connection detection mode, the response portion issues the instruction to output the response signal in the m-th output time period.

3. The storage device according to claim 2,
wherein the first to k-th terminals include a reset terminal, and
wherein the mode determination portion determines that the operation is the connection detection mode when a voltage level of the reset terminal is a voltage level representing a reset state in a predetermined time period after power activation.

4. The storage device according to claim 2,
wherein the response portion,
in the m-th output time period, changes a voltage level of the i-th terminal from a high-impedance state to a second voltage level, and then changes the voltage level thereof from the second voltage level to a first voltage level, and
in a time period other than the m-th output time period, sets the voltage level of the i-th terminal to the high-impedance state.

5. The storage device according to claim 2,
wherein the response portion includes
a counter that performs a process of counting an internal clock, and
a consistent determination section that determines consistency between a count value of the counter and a latency value corresponding to the ID information which is read out from the storage section, and
wherein when the count value is consistent with the latency value, the response portion issues the instruction to output the response signal.

6. The storage device according to claim 5,
wherein the counter starts a process of counting the internal clock at a timing when power-on reset is released after power activation.

7. The storage device according to claim 2,
wherein the response portion issues the instruction to output the response signal through a plurality of terminals among the first to k-th terminals.

8. A substrate comprising the storage device according to claim 1.

9. A substrate comprising the storage device according to claim 2.

10. A substrate comprising the storage device according to claim 3.

11. A substrate comprising the storage device according to claim 4.

12. A liquid container comprising the storage device according to claim 1.

13. A liquid container comprising the storage device according to claim 2.

14. A liquid container comprising the storage device according to claim 3.

15. A liquid container comprising the storage device according to claim 4.

16. A system comprising:
the storage device according to claim 1; and
a host device.

17. A system comprising:
the storage device according to claim 2; and
a host device.

18. A system comprising:
the storage device according to claim 3; and
a host device.

19. A system comprising:
the storage device according to claim 4; and
a host device.

20. A host device comprising:
a communication processing section that performs a process of communicating with first to n-th (n is an integer of 2 or more) storage devices through first to k-th (k is an integer of 2 or more) host side terminals; and
a monitoring section,
wherein the monitoring section monitors whether or not response signals are output from the first to n-th storage devices in each time period of first to n-th output time periods.
